(19) United States
(12) Patent Application Publication
(10) Pub. No.: US 2026/0225307 A1
(43) Pub. Date: Aug. 6, 2026

(54) METHOD FOR INCREASING SURFACE FRICTION OF A HOLLOW PLASTIC BOARD AND BOARD MANUFACTURED THEREBY

(71) Applicant: Shanghai Baifeng International Trading Co.,Ltd, Shanghai (CN)

(72) Inventor: JINJUN FANG, Lanxi (CN)

(21) Appl. No.: 19/578,737

(22) Filed: Mar. 25, 2026

(30) Foreign Application Priority Data
Dec. 19, 2025 (CN) 202511931899.3

(51) Int. Cl. B29C 59/04

(52) U.S. Cl. CPC B29C 59/04

(57) ABSTRACT

The present invention discloses a method for improving the surface friction of hollow plastic boards and a board manufactured thereby. The apparatus includes a frame, a driving assembly, and a lifting heating assembly. A roller frame is mounted on an upper portion of the frame, and the driving assembly and the lifting heating assembly are installed on the roller frame. A heating needle roller is internally provided with a cross-structured electric heating tube, and is combined with a dense needle-shaped surface structure, thereby improving heating uniformity and preventing slippage of the board body during conveying. This effectively ensures the clarity and consistency of the pressed surface textures on the board.

### CROSS-REFERENCE TO RELATED APPLICATIONS

This application claims priority to Chinese Patent Application No. 202511931899.3, filed on December 19, 2025, which is hereby incorporated by reference in its entirety.

### TECHNICAL FIELD

The present invention relates to the technical field of packaging material processing equipment, and in particular to a method for increasing surface friction of a hollow plastic board and a board manufactured thereby.

### BACKGROUND

Hollow plastic boards are plastic-based boards manufactured by special processing techniques to form hollow structures. Due to their high strength-to-weight ratio, durability, and cost-effectiveness, hollow plastic boards are widely used in packaging, logistics, and construction industries. Such boards are typically extruded from thermoplastic materials such as polypropylene (PP) or polyethylene (PE), and structurally comprise two outer walls and intermediate supporting ribs, forming a plurality of hollow channels.

However, due to the inherent smoothness of plastic surfaces, hollow plastic boards tend to exhibit low surface friction in many applications. For example, during stacking or transportation of goods on plastic pallets or similar boards, displacement or slipping easily occurs, which may cause product damage and safety hazards. For instance, in the prior art (Chinese Patent Application No. CN202020672093.3, filed on Apr. 27, 2020), a laminating device for plastic boards uses a mechanical structure composed of dual motors, transmission plates, turntables, and sliding blocks to drive a laminating plate to reciprocally apply pressure to plastic boards, replacing pneumatic cylinder driving and improving reciprocating speed and pressing efficiency.

At present, surface-pattern pressing equipment for hollow plastic boards in the packaging industry generally suffers from the following drawbacks: most heating rollers are equipped with only a single built-in electric heating tube, resulting in highly concentrated heat distribution and poor uniformity. Consequently, the clarity and consistency of surface texture pressing on the boards are difficult to guarantee, leading to insufficient heating uniformity and poor practical performance. Therefore, a method for increasing surface friction of hollow plastic boards and a board manufactured thereby is proposed to effectively solve the above problems.

### SUMMARY

An objective of the present invention is to provide a method for increasing surface friction of a hollow plastic board and a board manufactured thereby, so as to solve the problems in the prior art that most heating rollers are equipped with only a single heating tube, resulting in concentrated heat distribution, poor uniformity, and unstable clarity and consistency of pressed surface textures, thereby causing insufficient heating uniformity and poor practical applicability.

To achieve the above objective, the present invention provides the following technical solution:

The invention provides a method for increasing surface friction of a hollow plastic board and a board manufactured thereby, comprising a frame, a driving assembly, and a lifting heating assembly. The frame serves as a main load-bearing structure and is provided with adjustable support feet at its bottom. A roller frame is mounted at an upper end of the frame, and the driving assembly and the lifting heating assembly are mounted on the roller frame.

The lifting heating assembly is mounted at an upper inner portion of the roller frame and comprises a heating needle roller body and a lifting adjustment unit. A surface of the heating needle roller body is densely distributed with needle-like structures, and heating tubes are arranged inside the heating needle roller body for heating. Two ends of the heating needle roller body pass through lifting slots of the roller frame and are fixedly connected to connecting blocks by bolts, and the connecting blocks are detachably connected to telescopic ends of lifting cylinders.

The lifting adjustment unit comprises lifting cylinders and connecting blocks, and the telescopic ends of the lifting cylinders are mounted on lower end surfaces of the connecting blocks to drive the heating needle roller body to perform vertical height adjustment along the roller frame.

The driving assembly is located directly below the heating needle roller body inside the roller frame and comprises a driving roller body, a driving gear, and a rotating motor. One end of the driving roller body is sleeved with the driving gear, and a driving end of the rotating motor is connected to the driving roller body. The rotating motor drives the driving roller body to rotate and cooperate with the heating needle roller body to form a pressing gap adaptable to boards of different thicknesses.

An upper half structure of the roller frame is provided with two lifting slots penetrating frame plates, and lifting scales for height marking are arranged beside the lifting slots. The lifting slots serve as guide grooves, and end portions of the heating needle roller body are mounted in the lifting slots.

A lower half structure of the roller frame is provided with shaft holes and connecting seats. The shaft holes correspond to end portions of the driving roller body, and the connecting seats are mounted on end surfaces of the frame.

Through the above structure, the lifting slots adopt a high-precision linear guide rail design, and slot walls are subjected to quenching heat treatment, ensuring smooth sliding of the heating needle roller body during lifting without jamming or deviation. The lifting scales are manufactured by laser engraving, with scale precision reaching 0.01 mm. In combination with pneumatic feedback adjustment of the lifting cylinders, micron-level control of the pressing gap can be achieved, precisely matching processing requirements of hollow plastic boards with different thicknesses.

An extension plate is arranged in a middle portion of the roller frame to form a cylinder platform for mounting the lifting cylinders.

The cylinder platform is integrally formed with the roller frame by one-piece casting, and the platform surface is milled to ensure flatness error ≤ 0.02 mm, thereby providing a stable and flat mounting reference for the lifting cylinders.

Two ends of the heating needle roller body are connecting rods, and end portions of the connecting rods are provided with bifurcated structures forming double-rod lifting rods.

Heating tubes are arranged inside the heating needle roller body, and the heating tubes are mounted in a cross-shaped structure inside the heating needle roller body.

The connecting rods are made of high-strength alloy materials, and the bifurcated lifting rod design enables uniform transmission of driving force from the lifting cylinders to both ends of the heating needle roller body, preventing roller tilting caused by unilateral force and ensuring parallel contact between the needle roller surface and the board surface. The heating tubes use nickel-chromium alloy heating wires as heating elements, and the cross-shaped layout enables surface temperature distribution uniformity error ≤ ±5°C. Compared with conventional single heating tube structures, the heat coverage area is increased by more than 40%, effectively avoiding local overheating or insufficient heating of the board.

A conveyor belt is arranged at a rear side of the frame, and a table surface of the conveyor belt is flush with the driving roller body. The board body is conveyed into the pressing device from the conveyor belt surface through rollers.

The height difference between the conveyor belt surface and the driving roller body is ≤ 0.1 mm, forming a smooth transition channel, preventing jamming or edge damage of the board during transfer, and ensuring continuity of processing and product quality.

The method comprises the following steps:

S1. Starting the heating needle roller body, setting a needle tip temperature to 230°C, and heating for approximately 25 minutes until temperature stabilization;

S2. Adjusting a speed of the driving roller body to 15 m/min, and adjusting the height of the heating needle roller body according to board thickness to ensure controllable needle penetration depth;

S3. Supporting the board to be processed by rollers to prevent structural collapse during processing;

S4. Pressing heated needle tips into an outer wall of the board at a controlled depth sufficient to locally melt and displace plastic material to form protrusions without penetrating the outer wall; after needle retraction, the molten plastic cools and solidifies to form an integrated surface protrusion array.

The temperature of the needle tips is controlled to be higher than the melting point of the thermoplastic material, preferably 15–30°C higher than the melting point, ensuring rapid local melting of plastic material.

During pressing, local plastic melts, and after needle retraction, the molten plastic cools and solidifies to form raised edges surrounding central concave points without forming through-holes, thereby forming a high-friction protrusion array. The density of the protrusion array is adjustable within a range of 10 to 200 protrusions per square centimeter.

The hollow plastic board comprises a board body, wherein supporting ribs are arranged on an outer side of the board body, and hollow channels are formed inside the board body.

This structure ensures both structural strength and reduced weight, effectively reduces thermal conductivity of the board, minimizes heat transfer into the interior during hot pressing, prevents deformation of internal supporting ribs due to heating, and ensures overall rigidity of the board.

Regularly distributed anti-slip protrusions are formed on an outer surface of the board body, with a density of 10 to 200 protrusions per square centimeter. The anti-slip protrusions are integrally formed with the board body, without risks of delamination or detachment, and the service life is more than three times longer than that of conventional coated anti-slip boards.

Compared with the prior art, the present invention provides the following beneficial effects:

Improved heating uniformity and anti-sliding performance:

The heating needle roller body is internally provided with cross-structured heating tubes and externally provided with dense needle-like structures, improving heating uniformity, preventing sliding of the board during processing, and effectively ensuring clarity and consistency of pressed surface textures.

High controllability of roller adjustment:

The roller frame is provided with lifting slots and height scales, which not only provide vertical guidance for the heating needle roller body but also enable direct reading of adjustment height, preventing roller tilting and improving precision control of the pressing gap.

Efficient and precise lifting adjustment:

Lifting cylinders are used to drive vertical movement of the heating needle roller body. Compared with traditional manual screw adjustment, adjustment speed and precision are significantly improved, enabling rapid adaptation to boards of different thicknesses.

### BRIEF DESCRIPTION OF THE DRAWINGS

FIG. 1 is a front perspective structural schematic view of the present invention;

FIG. 2 is a front perspective structural schematic view of the frame and the roller frame of the present invention;

FIG. 3 is a side structural schematic view of the frame and the roller frame of the present invention;

FIG. 4 is a front structural schematic view of the driving roller and the heating needle roller of the present invention;

FIG. 5 is a structural schematic view of the roller frame of the present invention;

FIG. 6 is a rear structural schematic view of the roller frame of the present invention;

FIG. 7 is a perspective structural schematic view of the driving roller after separation;

FIG. 8 is a partial perspective structural schematic view of the heating needle roller of the present invention;

FIG. 9 is an enlarged schematic view of portion A in FIG. 8;

FIG. 10 is a front structural schematic view of the heating needle roller of the present invention;

FIG. 11 is a perspective structural schematic view of the board body of the present invention.

### Reference numerals:

1—frame; 2—roller frame; 21—lifting slot; 22—connecting seat; 23—cylinder platform; 24—lifting scale; 25—shaft hole;

3—driving roller; 4—heating needle roller; 41—connecting rod; 42—lifting rod; 43—heating tube;

5—rotating motor; 6—driving gear; 7—lifting cylinder; 8—connecting block;

9—conveyor belt; 10—board body; 11—anti-slip protrusion.

### DESCRIPTION OF EMBODIMENTS

The technical solutions of the embodiments of the present invention are described clearly and completely below in conjunction with the accompanying drawings. It should be understood that the described embodiments are only part of the embodiments of the present invention, rather than all embodiments. Based on the embodiments of the present invention, all other embodiments obtained by a person skilled in the art without creative effort shall fall within the scope of protection of the present invention.

The present invention provides a method for increasing surface friction of a hollow plastic board and a board manufactured thereby.

### Embodiment 1

In order to solve the problems in the prior art that most heating rollers are equipped with only a single electric heating tube, resulting in highly concentrated heat distribution and poor uniformity, such that the clarity and consistency of surface texture pressing of boards cannot be guaranteed, thereby causing insufficient heating uniformity and poor practical performance, the present invention discloses the following technical solution:

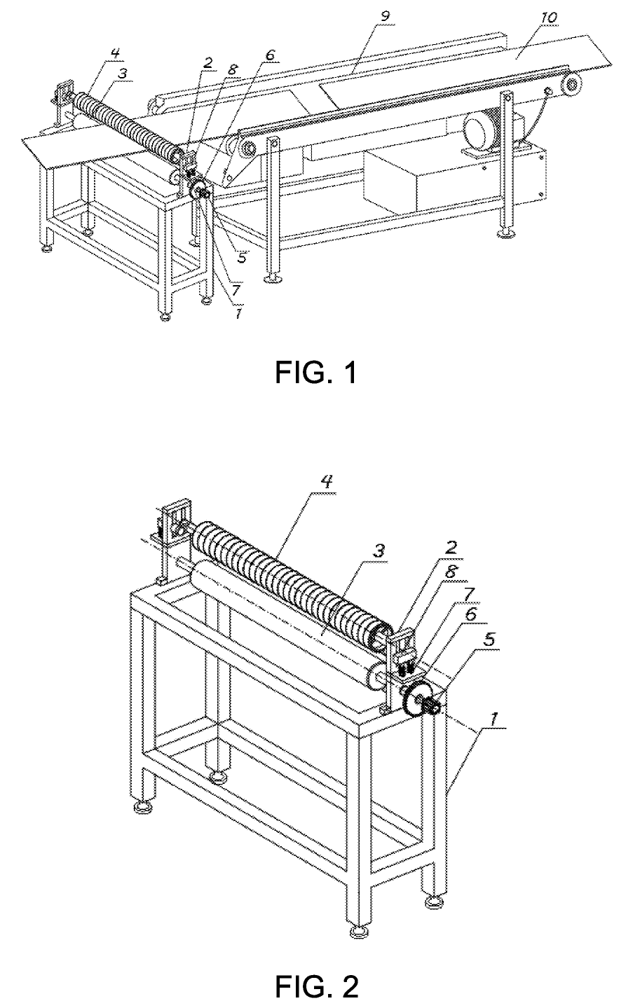

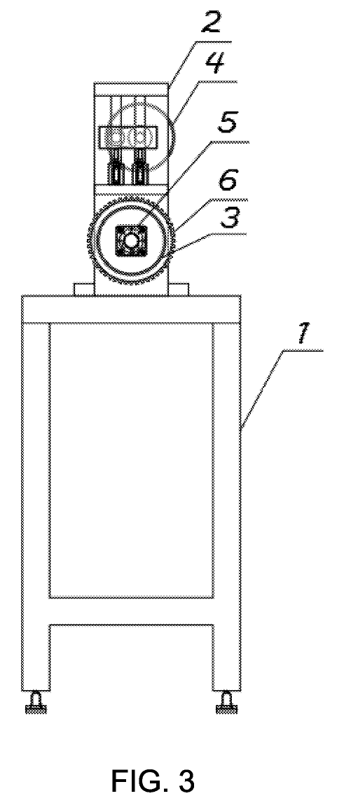

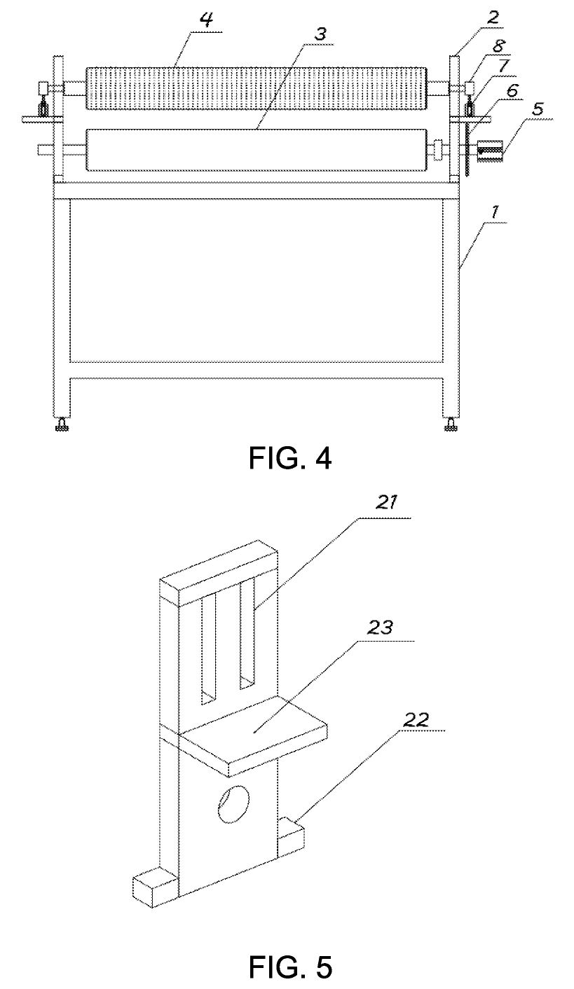

The apparatus comprises a frame 1, a driving assembly, and a lifting heating assembly. The frame 1 serves as a main load-bearing structure, and adjustable support feet are arranged at a bottom thereof. A roller frame 2 is mounted at an upper end of the frame 1. The frame 1 is first adjusted to a horizontal state by the adjustable support feet to ensure overall stability of the equipment, and then the roller frame 2 is mounted on the upper end of the frame 1 through connecting seats 22, thereby completing construction of the core mounting framework. Subsequently, end portions of the driving roller body 3 are correspondingly embedded into shaft holes 25 of a lower half structure of the roller frame 2, so as to complete positioning and installation of the driving assembly, as shown in FIG. 1–7.

The driving assembly and the lifting heating assembly are mounted on the roller frame 2. The lifting heating assembly is mounted at an upper inner portion of the roller frame 2 and comprises a heating needle roller body 4 and a lifting adjustment unit. A surface of the heating needle roller body 4 is densely distributed with needle-like structures, and heating tubes 43 are arranged inside the heating needle roller body 4 for heating. Two ends of the heating needle roller body 4 pass through lifting slots 21 of the roller frame 2 and are fixedly connected to connecting blocks 8 by bolts. The connecting blocks 8 are detachably connected to telescopic ends of lifting cylinders 7.

The lifting adjustment unit comprises lifting cylinders 7 and connecting blocks 8. Telescopic ends of the lifting cylinders 7 are mounted on lower end surfaces of the connecting blocks 8 to drive the heating needle roller body 4 to perform vertical height adjustment along the roller frame 2.

The driving assembly is located directly below the heating needle roller body 4 inside the roller frame 2 and comprises a driving roller body 3, a driving gear 6, and a rotating motor 5. One end of the driving roller body 3 is sleeved with the driving gear 6, and a driving end of the rotating motor 5 is connected to the driving roller body 3. The rotating motor 5 drives the driving roller body 3 to rotate, and the driving gear 6 assists in ensuring rotational stability. During rotation, the driving roller body 3 cooperates with the heating needle roller body 4 to convey the board body 10 forward at a uniform speed of about 15 m/min (adjustable according to feeding speed), as shown in FIGS. 1–3.

The upper half structure of the roller frame 2 is provided with two lifting slots 21 penetrating frame plates, and lifting scales 24 for height marking are arranged beside the lifting slots 21. The lifting slots 21 serve as guide grooves, and end portions of the heating needle roller body 4 are mounted in the lifting slots 21. The lower half structure of the roller frame 2 is provided with shaft holes 25 and connecting seats 22. The shaft holes 25 correspond to end portions of the driving roller body 3, and the connecting seats 22 are structures mounted on end surfaces of the frame 1.

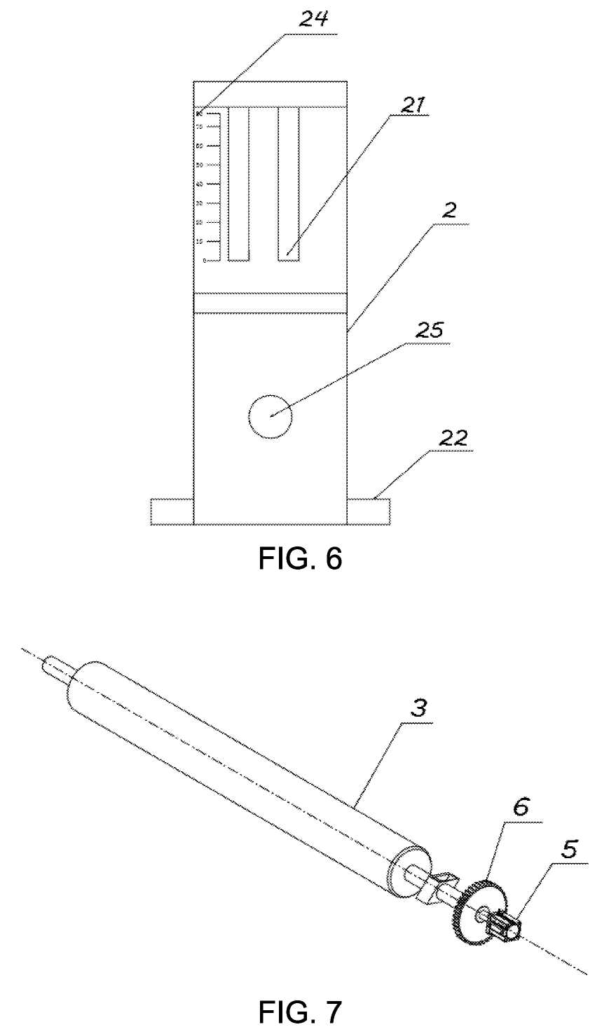

An extension plate is arranged in a middle portion of the roller frame 2 to form a cylinder platform 23 for mounting the lifting cylinders 7. Connecting rods 41 at both ends of the heating needle roller body 4 pass through the lifting slots 21 and are fixed by the connecting blocks 8. The lifting cylinders 7 are mounted on the cylinder platform 23, and their telescopic ends are connected to lower end surfaces of the connecting blocks 8, thereby forming a complete lifting adjustment unit. With reference to the lifting scales 24, the heating needle roller body 4 is driven by the lifting cylinders 7 to move vertically along the lifting slots 21, so as to adjust the pressing gap between the heating needle roller body 4 and the driving roller body 3 below, thereby adapting to the thickness of the board body 10, as shown in FIGS. 5 and 6.

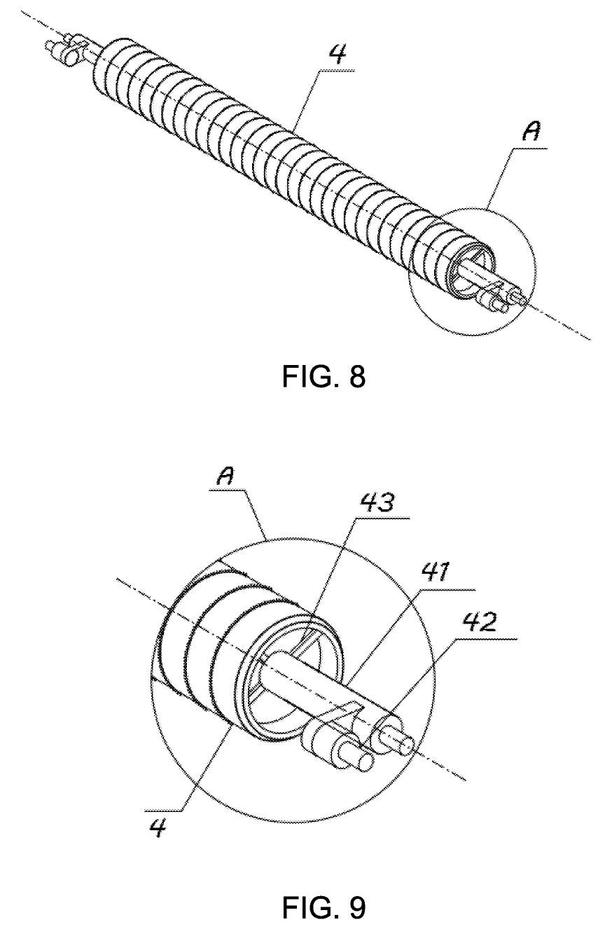

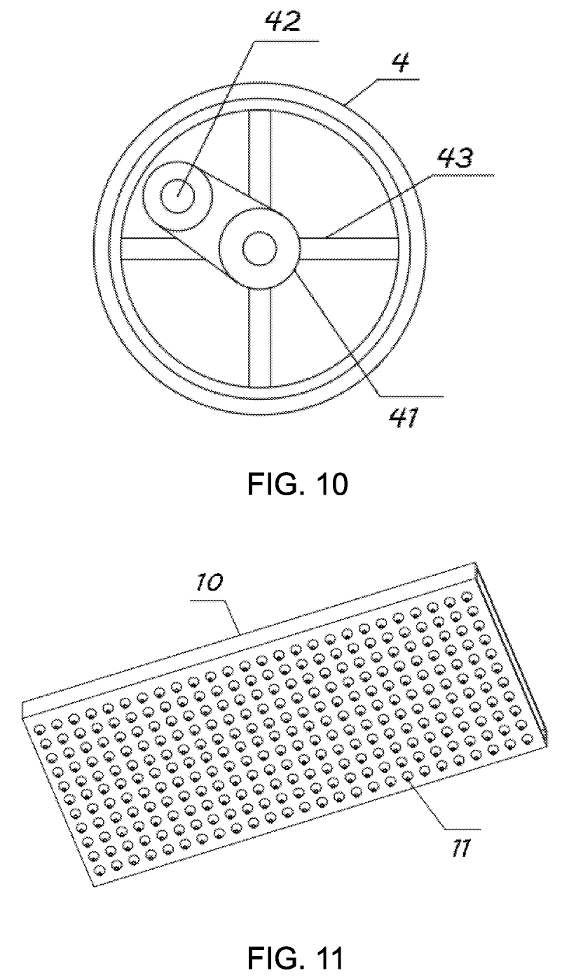

Two ends of the heating needle roller body 4 are connecting rods 41, and end portions of the connecting rods 41 are provided with bifurcated structures, forming double-rod lifting rods 42. Heating tubes 43 are arranged inside the heating needle roller body 4, and the heating tubes 43 are mounted in a cross-shaped structure inside the heating needle roller body 4. The heating tubes 43 are activated, and the temperature is set to 230°C. After approximately 25 minutes of heating, the temperature stabilizes at a level higher than the melting point of the thermoplastic material, thereby preparing for subsequent hot-press forming, as shown in FIGS. 8 –10.

A conveyor belt 9 is arranged at a rear side of the frame 1. A table surface of the conveyor belt 9 is flush with the driving roller body 3. The board body 10 is conveyed from the conveyor belt 9 into the pressing region through rollers. The board body 10 is stably conveyed between the heating needle roller body 4 and the driving roller body 3. The driving roller body 3 serves as a lower supporting structure to prevent structural collapse of the board body 10 during processing, as shown in FIG. 1.

Under the action of the heating tubes 43, the dense needle-like structures on the surface of the heating needle roller body 4 maintain a high temperature. When the board body 10 passes through the pressing gap, the high-temperature needle structures are pressed into an outer wall of the board body 10 at a controlled depth. Local plastic material melts and is displaced. After the needle tips are separated along with rotation of the heating needle roller body 4, the molten plastic cools and solidifies, forming a regularly distributed anti-slip protrusion array 11 (with a density of 10 to 200 protrusions per square centimeter) on the outer surface of the board body 10, without penetrating the outer wall, as shown in FIG. 1–4.

The board body 10 with formed anti-slip protrusions 11 continues to be conveyed forward under the combined action of the driving roller body 3 and the conveyor belt 9, and finally exits the apparatus to form a finished hollow plastic board with a high-friction surface, as shown in FIG. 11.

The method comprises the following steps:

S1. Starting the heating needle roller body 4, setting the needle tip temperature to 230°C, and heating for approximately 25 minutes until temperature stabilization;

S2. Adjusting the speed of the driving roller body 3 to 15 m/min, and adjusting the height of the heating needle roller body 4 according to board thickness to ensure controllable needle penetration depth;

S3. Supporting the board to be processed by rollers to prevent structural collapse during processing;

S4. Pressing heated needle tips into an outer wall of the board at a controlled depth sufficient to locally melt and displace plastic material to form protrusions without penetrating the outer wall; after needle retraction, the molten plastic cools and solidifies, forming an integrated surface protrusion array.

The temperature of the needle tips of the heating needle roller body 4 is controlled to be higher than the melting point of the thermoplastic material. In step S4, when the heated needles are pressed into the surface of the plastic board, local plastic material melts. After needle retraction, the molten plastic cools and solidifies to form raised edges surrounding central concave points without forming through-holes, thereby forming a high-friction protrusion array.

The hollow plastic board comprises a board body 10, wherein supporting ribs are arranged on an outer side of the board body 10, and hollow channels are formed inside the board body 10. Regularly distributed anti-slip protrusions 11 are formed on the outer surface of the board body 10, with a density of 10 to 200 protrusions per square centimeter.

The above describes the complete working process of the apparatus. Contents not described in detail in this specification belong to the prior art commonly known to those skilled in the art.

Although the present invention has been described in detail with reference to the foregoing embodiments, a person skilled in the art may still make modifications to the technical solutions described in the embodiments or make equivalent substitutions for some technical features. Any modifications, equivalent substitutions, and improvements made within the spirit and principles of the present invention shall fall within the scope of protection of the present invention.

What is claimed is:

1. An apparatus for increasing surface friction of a hollow plastic board, comprising:
a frame, a driving assembly, and a lifting heating assembly;
wherein the frame serves as a main load-bearing structure, and an adjustable support foot is arranged at a bottom thereof;
a roller frame is mounted at an upper end of the frame, and the driving assembly and the lifting heating assembly are mounted on the roller frame;
wherein:
the lifting heating assembly is mounted at an upper inner portion of the roller frame and comprises a heating needle roller body and a lifting adjustment unit;
a surface of the heating needle roller body is densely distributed with needle-like structures, and a heating tube is arranged inside the heating needle roller body for heating;
two ends of the heating needle roller body pass through lifting slots of the roller frame and are fixedly connected to connecting blocks by bolts, and the connecting blocks are detachably connected to telescopic ends of lifting cylinders;
the lifting adjustment unit comprises the lifting cylinders and the connecting blocks, and telescopic ends of the lifting cylinders are connected to lower end surfaces of the connecting blocks so as to drive the heating needle roller body to perform vertical height adjustment along the roller frame;
the driving assembly is located directly below the heating needle roller body inside the roller frame and comprises a driving roller body, a driving gear, and a rotating motor;
one end of the driving roller body is sleeved with the driving gear, a driving end of the rotating motor is connected to the driving roller body, and the rotating motor drives the driving roller body to rotate and cooperate with the heating needle roller body to form a pressing gap adaptable to boards of different thicknesses.

2. The apparatus according to claim 1, wherein:
an upper half structure of the roller frame is provided with two lifting slots penetrating frame plates, lifting scales for height marking are arranged beside the lifting slots, and the lifting slots serve as guide grooves, wherein end portions of the heating needle roller body are mounted in the lifting slots;
a lower half structure of the roller frame is provided with shaft holes and connecting seats, the shaft holes correspond to end portions of the driving roller body, and the connecting seats are structures mounted on an end surface of the frame.

3. The apparatus according to claim 1, wherein:
a cylinder platform formed by an extension plate is arranged in a middle portion of the roller frame for mounting the lifting cylinders.

4. The apparatus according to claim 1, wherein:
two ends of the heating needle roller body are connecting rods, ends of the connecting rods are provided with bifurcated structures forming double-rod lifting rods;
a heating tube is arranged inside the heating needle roller body, and the heating tube is mounted in a cross-shaped structure inside the heating needle roller body.

5. The apparatus according to claim 1, wherein:
a conveyor belt is arranged at a rear side of the frame, a table surface of the conveyor belt is flush with the driving roller body, and a board body is conveyed from the table surface of the conveyor belt into the apparatus for pressing through rollers.

6. A method for increasing surface friction of a hollow plastic board, characterized in that the method is performed using the apparatus according to claim 1, and comprises the following steps:
1S. starting the heating needle roller body, setting a needle tip temperature of the heating needle roller body to 230°C, and heating for approximately 25 minutes until temperature stabilization;
2S. adjusting a speed of the driving roller body to 15 m/min, and adjusting a height of the heating needle roller body according to board thickness to ensure controllable needle tip penetration depth;
3S. supporting a board to be processed by rollers to prevent structural collapse during processing;
4S. pressing heated needle tips into an outer wall of the board at a controlled depth, such that the depth is sufficient to locally melt and displace plastic material to form protrusions without penetrating the outer wall, and after needle retraction, molten plastic cools and solidifies to form an integrated surface protrusion array.

7. The method according to claim 6, wherein:
the temperature of the needle tips of the heating needle roller body is controlled to be higher than a melting point of a thermoplastic material.

8. The method according to claim 6, wherein:
in step S4, when heated needles are pressed into a surface of the plastic board, local plastic material is melted, and after needle retraction, the molten plastic cools and solidifies to form raised edges surrounding central concave points without forming through-holes, thereby forming a high-friction protrusion array.

9. A hollow plastic board prepared by the method according to claim 6, comprising a board body,
wherein an outer side of the board body is provided with supporting ribs, and hollow channels are formed inside the board body.

10. The hollow plastic board according to claim 9, wherein:
regularly distributed anti-slip protrusions are formed on an outer surface of the board body, with a density of 10 to 200 protrusions per square centimeter.
